(19) United States
(12) Patent Application Publication
(10) Pub. No.: US 2022/0382275 A1
(43) Pub. Date: Dec. 1, 2022

(54) COMPUTER READABLE MEDIUM, APPARATUS, AND METHOD FOR CONTROLLING VEHICLE MOVEMENT

(71) Applicant: JAGUAR LAND ROVER LIMITED, Whitley (GB)

(72) Inventors: Patrick Martin, Beaverton, OR (US); Carl Barrett, Coventry (GB); Matthew Mercer, Coventry (GB); Mutlu Isik, Coventry (GB); Alexander Voets, Coventry (GB)

(21) Appl. No.: 17/333,846

(22) Filed: May 28, 2021

(51) Int. Cl. G05D 1/00; B60W 30/06; G06F 3/0484; G06F 3/0488

(52) U.S. Cl. CPC G05D 1/0016; B60W 30/06; G06F 3/04847; G06F 3/0488; G05D 2201/0213

(57) ABSTRACT

A vehicle, device, and non-transitory computer readable medium having stored thereon computer readable instructions that, when executed by a processor, cause performance of a method to perform a defined maneuver. The method includes: detecting, on a touch screen of a device, a first user input for a vehicle, remote to the device, to perform the defined maneuver, wherein the first user input includes a touch moving from a first region on the touch screen to a second region on the touch screen, and maintenance of the touch in the second region on the touch screen; and transmitting, by the device, a signal relating to the defined maneuver to the vehicle in dependence on maintenance of the touch in the second region.

### TECHNICAL FIELD

The present disclosure relates to an apparatus and method for controlling vehicle movement and particularly, but not exclusively, remotely controlling vehicle movement. Aspects of the invention relate to computer readable medium, to a device, and to a vehicle.

### BACKGROUND

It is known for a vehicle to perform a defined maneuver, such as an automatic, or semi-autonomous, parking maneuver. The vehicle may be instructed to perform the maneuver remotely e.g. via a mobile device at which an input is received to instruct the vehicle to perform the maneuver. Various forms and types of such an input are known. For example: a single press of a key provided by a mobile device (e.g., a soft key or a hard key of the mobile device) may lead to instructing the vehicle to perform the maneuver. In another example, a touch-and-hold on a touch screen of a mobile device while a specific user interface is displayed may lead to instructing the vehicle to perform the maneuver.

It may be preferable for the vehicle to perform the maneuver only when, and for so long as, the user wishes, or intends, or consents, or wants etc. for the maneuver to be performed. That is, the maneuver should not be performed if a user does not intend for it to be performed or stops intending the performing of the maneuver while it is underway. It will be appreciated that time may be an important factor. That is to say the intention of the user may change quickly, and remote control of the vehicle should account for this; ensuring that the maneuver is not performed for any longer than necessary once the user no longer intends for the maneuver to be performed. For example, a user may stop intending to perform the maneuver, or no longer wish the perform the maneuver, when the user becomes incapacitated while the maneuver is underway or ready to be performed.

Further, it may be preferable that the vehicle performs the maneuver under supervision of a user of the mobile device which is providing the vehicle with the instruction to perform the maneuver. That is, a user should be supervising the performing of the maneuver by the vehicle so as to be able to pause or stop the maneuver before completion in the event of a change in conditions necessitating such; e.g., a change in the environment of the vehicle necessitating a pausing of the maneuver. An example of this may be when a change in conditions that results in a hazard occurs in the vicinity of the vehicle, such that a user would want to pause, stop or cancel the maneuver (user intervention) upon noticing said change.

Known methods of instructing the vehicle to perform a maneuver are unable to satisfactorily address the above-mentioned preferences.

For example, a method where the user input to instruct the vehicle to perform maneuver is a single press of a key of a mobile device does not easily allow for a user to indicate that they no longer intend the maneuver to be performed to the system, in that the user must identify and provide the mobile device with another input to achieve this, where this process would consume time. Furthermore, such a user input may be triggered accidentally, as it merely requires a single press of a single key.

Similarly, a method where the user input to instruct the vehicle to perform maneuver is a touch-and-hold on a touch screen of a mobile device may be triggered accidentally; for example, where the user accidentally contacts the screen without their knowledge, such as when the mobile device and a user's hand are both in the same pocket. Furthermore, withdrawing consent for the maneuver may be difficult in times when user function is inhibited (due to health reasons, for example), as the maneuver may continue to be performed so long as the user is maintaining a touch anywhere on the touch screen.

Accordingly, there is need for a device, method and system which both facilitates user supervision of the maneuver and controlling user intention for the performing of the maneuver.

### SUMMARY

Aspects and embodiments of the invention provide computer software, a device, and a vehicle as claimed in the appended claims.

According to an aspect of the invention, there is provided a non-transitory computer readable medium comprising computer readable instructions that, when executed by a processor, cause performance of a method comprising: detecting, on a touch screen of a device, a first user input for a vehicle, remote to the device, to perform a defined maneuver; and transmitting, by the device, a signal relating to the defined maneuver to the vehicle in dependence on maintenance of the first user input.

According to an aspect of the invention, there is provided a non-transitory computer readable medium comprising computer readable instructions that, when executed by a processor, cause performance of a method comprising: detecting, on a touch screen of a device, a first user input for a vehicle, remote to the device, to perform a defined maneuver, wherein the first user input comprises a touch moving from a first region on the touch screen to a second region on the touch screen, and maintenance of the touch in the second region on the touch screen; and transmitting, by the device, a signal relating to the defined maneuver to the vehicle in dependence on maintenance of the touch in the second region. Advantageously, the method of the computer readable instructions may improve functionality in the remote causing of a vehicle to perform the defined maneuver.

The method may comprise one or more of: stopping transmitting the signal if it is detected that the touch is no longer maintained in the second region; and modifying the signal if it is detected that the touch is no longer maintained in the second region. Advantageously, various methods of pausing the performing of the defined maneuver are specified, where the former option reduces power consumption and can allows for control of the vehicle without the need to transmit a specific signal, and the latter option provides further communication with the vehicle.

The modified signal may instruct the vehicle to pause performing the defined maneuver.

The method may comprise: if it is detected that the touch is no longer maintained in the second region, displaying a message indicating how the defined maneuver can be resumed. Advantageously, the message guides and assists a user through the technical task of controlling the vehicle to perform the defined maneuver by interacting with the device.

The signal may instruct the vehicle to begin performing the defined maneuver. Advantageously, effective functionality is improved by transmitting the instruction to begin performing the defined maneuver in dependence on maintenance of the touch in the second region.

The touch may move a slider control, displayed on the touch screen, from the first region to the second region. Advantageously, the slider control provides a mechanism enabling user input for controlling the vehicle to perform the defined maneuver.

Maintenance of the touch in the second region may comprise maintaining the displayed slider control in the second region.

An indication of a sliding direction may be displayed associated with the slider control. Advantageously, this provides an indication of how to provide the first user input, thereby guiding the user through this interaction.

A message instructing how to operate the slider control may be displayed associated with the second region, before the first user input is detected, and/or a message instructing how to stop the defined maneuver may be displayed associated with the first region, when the slider control is moved or moving to the second region.

Advantageously, this provides an indication of how to provide the first user input, thereby guiding the user this interaction, and/or provides an indication of how to stop or pause the defined maneuver, thereby guiding the user through this interaction.

Optionally: the first region may be located to the left of the second region in a graphical user interface, GUI, associated with the defined maneuver displayed on the touch screen; the first region may be located to the right of the second region in the GUI displayed on the touch screen; the second region may be located around the first region in the GUI displayed on the touch screen; or the second region may comprise two or more separate regions displayed in the GUI on the touch screen.

The location of the first region on the touch screen and the location of the second region on the touch screen may be in dependence on a setting stored in a memory of the device. Advantageously, providing the first and second regions in consistently in the same locations facilitates a user in subsequent performances of the method.

The location of the first region on the touch screen and the location of the second region on the touch screen may be in dependence on the device being configured for left-handed use or right-handed use.

Advantageously, providing the first and second regions in locations according to whether the user prefers to use their left hand or right hand improves user convenience.

Optionally, when the second region comprises two or more separate regions: moving the touch from the first region to the second region may comprise moving the touch from the first region to one of the two or more separate regions; and maintenance of the touch in the second region may comprise maintenance of the touch in the one or the two or more separate regions. Advantageously, providing a plurality of second regions provides more freedom to the user and increases user convenience.

The method may comprise: detecting that the touch is no longer maintained in the second region; and displaying, on the touch screen, one or more of: an item for changing a power mode of the vehicle, an item associated with locking the vehicle, an item for ending performing of the defined maneuver, an item for returning to performing of the defined maneuver, and an item for undoing the defined maneuver. Advantageously, options for related vehicle actions following the completion of the defined maneuver are presented to a user for easy selection.

The method may comprise: detecting a second user input to select one of the displayed one or more items; and transmitting another signal to the vehicle in dependence on the selected item.

Advantageously, further remote control of the vehicle is facilitated.

The method may be performed only if a user is authenticated. Advantageously, vehicle security is increased by this requirement.

The method may comprise: displaying a first user interface, UI, on the touch screen when the first user input is not being detected; and displaying a second UI, different to the first UI, on the touch screen while the first user input is being detected.

Advantageously, the change in the UI informs a user that the instruction to perform the defined maneuver is being sent to the vehicle.

Optionally, a message indicating that the defined maneuver is being performed may be displayed on the second UI.

The method may comprise displaying an indication of the defined maneuver on the touch screen.

Advantageously, the user is kept aware of the defined maneuver to be performed.

The method may comprise: displaying at least one defined maneuver for the vehicle on the touch screen; and detecting a selection of the defined maneuver from the displayed at least one defined maneuver, before detecting the first user input.

Advantageously, selection of a defined maneuver to be performed is made more convenient.

Optionally, prior to being displayed, the at least one defined maneuver may each be determined to be a candidate defined maneuver which the vehicle is currently capable of performing.

Advantageously, by only indicating defined maneuvers that the vehicle is capable of performing, user frustration is reduced.

Determining a candidate defined maneuver which the vehicle is currently capable of performing may be in dependence on one or more of: information received from the vehicle; information on an environment of the vehicle; information on a type of the vehicle; information on a location of the vehicle; information acquired from a sensor of the device; and information on size of the vehicle.

The displayed at least one defined maneuver may comprise one or more of: a parallel park maneuver, a perpendicular park maneuver, a forward maneuver, a forward-left maneuver, a forward-right maneuver, a reverse maneuver, a reverse-left maneuver, a reverse-right maneuver, and a longitudinal adjustment maneuver.

The method may comprise: receiving, from the vehicle, information relating to the performing of the defined maneuver; and determining whether the vehicle has completed the defined maneuver in dependence on the received information.

Advantageously, the device may have knowledge of the status of the performing of the defined maneuver so as to be able to react accordingly, such as by stopping.

The method may comprise: if it is determined that the vehicle has completed the defined maneuver, stopping transmitting the signal.

Advantageously, this may reduce power consumption in the device.

According to an aspect of the invention, there is provided a device comprising: a touch screen; at least one processor; and any of the non-transitory computer readable medium as described above; wherein the at least one processor is configured to execute the instructions to cause performance of the method.

Accordingly to an aspect of the invention, there is provided a device, comprising: a touch screen; input means configured to detect, on the touch screen, a first user input for a vehicle to perform a defined maneuver, wherein the first user input comprises a touch moving from a first region on the touch screen to a second region on the touch screen, and maintenance of the touch in the second region on the touch screen; and output means configured to transmit, by the device, a signal relating to the defined maneuver to the vehicle in dependence on maintenance of the touch in the second region.

The device may comprise: control means configured to control the input means and the output means.

The input means may comprise an input circuit for detecting the first user input. The output means may comprise an output circuit for transmitting the signal. The control means may comprise a control circuit including one or more control devices such as electronic processing devices.

Optionally, at least one of: the device may be required to have at least a predetermined battery level remaining in order to transmit the signal; and the device may be required to remain within a predetermined distance from the vehicle in order to transmit the signal. Advantageously, the former option may ensure that a device does not run out of battery mid-way through instructing the vehicle to perform the defined maneuver, and the latter option may improve effectiveness.

According to an aspect of the invention, there is provided a vehicle comprising: input means configured to receive, from a device, a signal relating to a defined maneuver; output means configured to output a movement signal to cause an application of torque to one or more wheels of the vehicle to move the vehicle; and control means configured to control the output means to output the movement signal in dependence on the signal being received from the device.

The input means may comprise an input circuit for receiving the signal. The output means may comprise an output circuit for outputting the movement signal. The control means may comprise a control circuit including one or more control devices such as electronic processing devices.

The signal may be received from the device while a first user input is provided to the device.

According to an aspect of the invention, there is provided a system comprising any device as described above, and any vehicle as described above.

Any controller or controllers described herein may suitably comprise a control unit or computational device having one or more electronic processors. Thus the system may comprise a single control unit or electronic controller or alternatively different functions of the controller may be embodied in, or hosted in, different control units or controllers. As used herein the term “controller” or “control unit” will be understood to include both a single control unit or controller and a plurality of control units or controllers collectively operating to provide any stated control functionality. To configure a controller, a suitable set of instructions may be provided which, when executed, cause said control unit or computational device to implement the control techniques specified herein. The set of instructions may suitably be embedded in said one or more electronic processors. Alternatively, the set of instructions may be provided as software saved on one or more memory associated with said controller to be executed on said computational device. A first controller may be implemented in software run on one or more processors. One or more other controllers may be implemented in software run on one or more processors, optionally the same one or more processors as the first controller. Other suitable arrangements may also be used.

Within the scope of this application, it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows a schematic illustration of a device according to an embodiment of the present invention;

FIG. 2 shows a graphical user interface (GUI) according to an embodiment of the present invention;

FIG. 3 show a GUI according to an embodiment of the present invention;

FIG. 4 show a GUI according to an embodiment of the present invention;

FIG. 5 show a GUI according to an embodiment of the present invention;

FIG. 6 shows a method flow diagram according to an embodiment of the present invention; and

FIG. 7 shows a vehicle in accordance with an embodiment of the invention.

### DETAILED DESCRIPTION

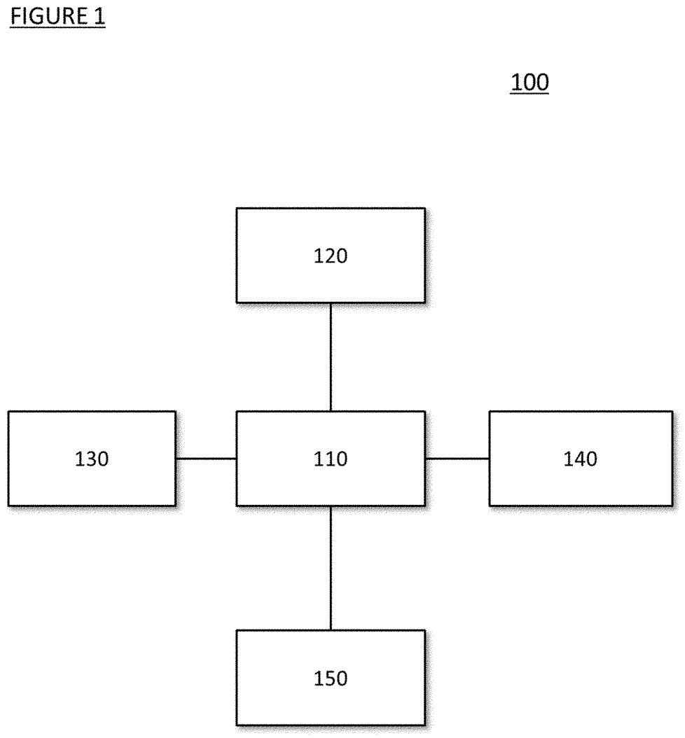

A device 100 in accordance with an embodiment of the present invention is described herein with reference to the accompanying FIG. 1. In certain embodiments of the present invention, the device 100 is a mobile device which is remote from a vehicle 700, for example a smartphone, a laptop, an electronic key fob or a tablet device.

With reference to FIG. 1, the device 100 comprises a control means 110, a display means 120, an input means 130, a storage means 140 and a communication means 150. In certain embodiments, the device 100 may include a bus (not shown); the bus may, for example, include a circuit that connects the components 110 to 150 to each other and transmit communications (e.g., a control message and/or data) between them.

The storage means 140 may comprise one or more memory devices for storing data therein. The storage means 140 may include a volatile memory and/or a non-volatile memory. The storage means 140 may, for example, store an instruction or data associated with at least one other components of the device 100. According to an embodiment, the storage means 140 may store a software and/or a program.

The display means 120 may comprise a display unit 120 configured to output data. In certain embodiments, the display means 120 may include a touch screen. The touch screen may be configured to receive at least one of touch, gesture, proximity, or hovering using a part of a user's body or other input object such as a stylus. For example, the touch screen may be configured to receive a touch, gesture, proximity, and/or hovering input from one or more of the user's fingers.

The input means 130 may comprise an input unit 130 configured to receive an input, for example an input for controlling one or more functions and/or operations of the device 100. A touch screen included in the device 100 may be considered to form part of the input means 130 and/or part of the display means 120; that is, without limitation, a touch screen may be included in the input means 130 only, in the display means 120 only, or in both input means 130 and display means 120. A plurality of touch screens may also be provided, separated or shared between the display means 120 and the input means 130 in any manner as desired.

The communication means 150 may comprise a communication unit 150 configured to wired or wirelessly transmit and/or receive a signal from one or more external devices. In certain embodiments, the communication means 150 may comprise communication circuitry and/or one or more antenna. In certain embodiments, the communication means 150 is configured to communicate with a control means of a vehicle 700. In certain embodiments, the communication means 150 is configured to communicate with an external device and/or a server, in addition to the vehicle 700.

For example, the communication means may be configured to communicate via a short-range wireless method (such as Bluetooth, Wi-Fi, RF, WiFi Direct, Zigbee etc.) or a long-range wireless method (such as GPRS, LTE, 5G-NR, satellite or other appropriate cellular means). As will be discussed below in relation to various embodiments of the present invention, the control means 150 may be configured to transmit a signal(s) relating to a defined maneuver and/or the performing thereof to the vehicle 700.

In certain embodiments, communications between the device 100 and the vehicle 700 may include an authentication procedure, in which the device 100, or a user thereof, is authenticated so as to be allowed access to the vehicle 700 functionality and/or communicate signals to and/or from the vehicle 700. Details of an example authentication procedure will be given below.

The control means 110 may include one or more electronic processing devices such as an electronic processor. The processor may operably execute computer readable instructions stored in the one or more memory devices, such as a software or a program stored in one or more memory devices included in the storage means 140.

Computer readable instructions in accordance with embodiments of the present invention may, when executed by the processor, cause performance of a method such as one of those that will be described herein and/or cause the device 100 to perform one or more operations and/or functions as will be described herein.

It will be appreciated that the control means 110, for example, may execute an operation or data processing relating to control and/or communication of at least one other component of the device 100. That is, in the following where it is described that the control means 110 is configured to perform an operation or function, this may be understood as the control means being configured to control another component (e.g., the touch screen, or the communication means 150) to perform said operation or function, or even that said other component itself is performing said operation or function.

In certain embodiments, the control means 110 is configured to: detect, on the touch screen, a user input for a vehicle 700, which is remote to the device 100, to perform a defined maneuver, wherein the user input comprises a touch moving from a first region on the touch screen to a second region on the touch screen, and maintenance of the touch in the second region on the touch screen; and transmit a signal relating to the defined maneuver to the vehicle 700 in dependence on maintenance of the touch in the second region. It is advantageous to refer to the user input to perform the defined maneuver as a first user input, as later other user inputs will be described. Examples of a defined maneuver may include, but are not limited to, a semi-autonomous, parking maneuver, forward or backward maneuver, and precision longitudinal adjustment.

The first user input provides technical advantages over other user inputs for instructing performance of a defined maneuver, including improving an ease of use and functionality. The inventors carried out confidential, in-house research to identify an input which balances a physical requirement to perform, a mental requirement to perform, and user frustration, while still allowing for suitably safe remote control of a vehicle 700. Said research involved considering the first user input as defined above alongside other user inputs, including a user input requiring a constantly moving (freehand) touch to be applied to a touch screen, a user input requiring touch constantly moving in a circular motion on a touch screen, and a user input requiring two separate touch inputs to be simultaneously provided on a touch screen.

The physical requirement relates to what is physically required of a user to provide the input. For the first touch input, for example, this relates to: the touching on the first region, the moving of the touch to the second region, and the maintenance of the touch on the second region. The inventors found that first user input was reported as being least physically taxing when compared to other user inputs included in the research.

The mental requirement relates to what is cognitively required of a user to provide the input. For the first touch input, this largely relates to the need to maintain the touch in the second region so as to keep instructing the vehicle 700 to perform the defined maneuver until the defined maneuver is completed. For the other user inputs, this largely relates to: ensuring the touch keeps moving in a freehand pattern on the touch screen, or ensuring the touch moves in suitably circular motions, or ensuring the two touch inputs are synchronized as required. The inventors found that the first user input was reported to be the least mentally demanding, compared to the other user inputs considered. That is, compared to the other user inputs, the first user input was reported to be the simplest to maintain, this meant a user could more-easily supervise the vehicle 700 while it performed the defined maneuver instead of having to pay attention to the device 100 so as to ensure the user input is being provided correctly.

User frustration relates to the ease with which an input allowed a user to instruct the vehicle 700 to perform the defined maneuver. For example, frustration increases when the input requires a complex movement from the user, such that a user may struggle to consistently provide the correct input for instructing the vehicle 700. It was reported that the first user input was the least frustrating.

Accordingly, the outcome of the research was that the first user input is considered to have a relatively low physical requirement, a relatively low mental requirement, and results in a relatively low level of user frustration. The first user input is concluded to provide technical advantages over other types of user input, while still also ensuring the safety requirements for remotely controlling vehicle 700 movement, in that releasing of the touch from the second region may immediately cause the vehicle 700 to pause performing the defined maneuver. As such, if a user becomes incapacitated while instructing the vehicle 700 to perform the defined maneuver, it is highly likely that the touch will be removed from the second region and so the vehicle 700 will pause performing the defined maneuver. The first user input provides improves functionality over other inputs, in that the low mental requirement allows a user to more-attentively supervise the moving of the vehicle 700 in performing the defined maneuver. Furthermore, the low physical requirement means correctly providing the first user input to the device 100 may not prove overly challenging to users.

In certain embodiments, the first user input may comprise a first part in which a touch-down with an object is made on the first region (for example, by the user pressing a finger or stylus on the first region), a second part in which the object, without being removed from the touch screen, is moved to the second region (for example, by the user dragging the finger or stylus from the first region across a portion of the touch screen to the second region), and a third part in which the object is maintained in the second region (for example, by the user holding the finger or stylus on/in the second region of the touch screen). It will be understood that these three parts of the first touch input may be considered as individual inputs in their own right, or these three parts may be considered as a single, continuous input, or even two of the parts may be considered as a single, continuous input while the other is regarded separately. The first user input is not limited to the above-mentioned parts and may include one or more further parts.

Herein, while reference is made to a “touch” on the touch screen, it will be appreciated that this may not necessarily be a direct touch on the touch screen but could instead include a hovering above the touch screen. That is, the device 100, or the touch screen thereof, may be configured to detect an object hovering above a surface of the touch screen within a predetermined range, and may be configured to treat this hovering input the same as detecting a direct touch on the touch screen.

In certain embodiments, the first region on the touch screen may be a predefined region (or predefined area or portion) of the touch screen or of a GUI associated with performing the defined maneuver which is provided by the control means 110 on the touch screen. An indication of the first region may be displayed in the predefined region.

For example, the first region may be indicated as a 2-dimensional or 3-dimensional object/icon on the touch screen, the first region may be a portion of a window or object included in the GUI, or the first region may be a predefined region on the touch screen. For example, the first region may be rendered a specific shape, such as a circle, oval, rectangle, square, star etc., or the first region may be set as a portion of a window displayed on the touch screen. The indication of the first region may include one or more different colours and may be a different colour to a background element (e.g., a different colour to a GUI window on which the indication of the first region is located). The indication of the first region may also include a symbol, such as an arrow which indicates the direction to the second region. In certain embodiments, the location of the first region on the touch screen may be set in dependence on a setting stored in the memory means 140.

In certain embodiments, the first region may include an interactable icon or item of the

GUI. For example, the icon may be a slider control, where the slider control may be moveable only forwards and backwards in the direction of the second region from the first region. The direction of the second region may be indicated by the slider control itself, such as by an arrow displayed on the slider control which points in the direction of the second region or the direction(s) in which the slider may be moved, and/or may be indicated separately on the touch screen. Maintenance of the slider control in the second region may include maintaining (or holding) the displayed slider control in the second region.

In certain embodiments, the second region on the touch screen may be another predefined region (or predefined area or portion) of the touch screen or of a/the GUI associated with performing the defined maneuver provided by the device 100 on the touch screen. An indication of the second region may be displayed in the other predefined region. The second region may be different to the first region.

In certain embodiments, no part of the touch screen within the second region may also be included in the first region—the first and second regions are not overlapping. For example, the first region may be set as a circular region in the centre of the touch screen (at a top, bottom or middle portion of the touch screen, for example) while the second region may be set as a circular region located above, below, left, right or diagonally from the first region and not overlapping with the first region. In certain embodiments, the location of the second region on the touch screen may be set in dependence on a setting stored in the memory means 140. In another embodiment, the location of the second region may be set in dependence on the location of the first region.

In certain embodiments, a setting, stored in the device 100, which configures a location of the first region and the second region on the touch screen may correspond to a left-handedness or a right-handedness of a user. That is, a user may configure the device 100 according to a preference to use their left hand or their right hand, and the device 100 may user this information to determine how to position the first region and the second region on the touch screen. A right-handed user may, for example, hold the device 100 in their left hand to make it easier to control the device 100 using their right hand. In this case, if the device 100 is configured/set for a right-handed user, the control means 110 may display the first region and/or second region in consideration of an approximate position of a thumb of the left hand of the user, such that the first region and/or the second region may be expected to be within reach of said thumb while the device 100 is being held in the left hand of the user. This may aid in providing one-handed functionality for a method of controlling performance of a defined maneuver.

In certain embodiments, the second region may be indicated as a 2-dimensional or 3-dimensional object/icon on the touch screen, or the second region may be a portion of a window or object included in a/the GUI associated with performing the defined maneuver. In other words, the second region may be defined in similar terms to the first region but is associated with a different area of the touch screen (or a different area of a GUI provided by the device 100 on the touch screen).

In certain embodiments, the second region may not be displayed or indicated on the touch screen (or in the GUI) until the touch on the first region is received/detected. That is, before the touch on the first region is detected/received, the touch screen only indicates the first region and then, when the touch on the first region occurs, the touch screen indicates the second region. It will be appreciated that, by only indicating the first region before the touch is detected, a user will not confuse the first region and the second region; further, by indicating the second region when the first region is touched, the user's attention may be drawn to this newly-indicated area of the touch screen, aiding their comprehension.

In certain embodiments, the locations of the first region and the second region may not be predefined but instead the first region is set as a location, on the touch screen, which a user initially touches (for example, in response to a prompt, from the device 100, to touch anywhere on the touch screen), where the second region is then set as an area of the touch screen located away from the newly-set first region.

For example, if the user touches a bottom-right of the touch screen in response to a prompt to touch anywhere on the touch screen, the control means 110 may set an area at the touched located to be the first region. The control means 110 may then set the second region as: an area to the left of the first region on the touch screen (for example, at the bottom-left or centre-left of the touch screen), an area above the first region on the touch screen (for example, at the top-right or centre-right or the touch screen), or as an area diagonally removed from the first region on the touch screen (for example, at the middle-centre or top-left on the touch screen). According to this method, a first region is freely defined, increasing user convenience, while the second region is dynamically defined based on a location of the first region so as to be removed from the first region (i.e., non-overlapping).

In certain embodiments, the first region and the second region may be the same size (i.e., an area within each region may be the same, or the dimensions of each region may be the same) or different sizes. The size of the first region and/or the second region may also be static or dynamic. For example, the size of one or more of the first and second regions may change (increase or decrease) when the first user input touch on the first region occurs, and/or when the touch moves to the second region, and/or when the touch is being maintained in the second region.

In certain embodiments, a plurality of second regions may be set and/or displayed on the touch screen, where each second region is located in a different direction from the first region. In such an embodiment, in providing the first user input a user may have the option of moving the touch from the first region to any one of these second regions and maintaining the touch in the one of the second regions. Each second region of the plurality of second regions may be defined in the same way as the second region in the case of there being only a single second region, as has been described in detail elsewhere. For example: none of the second regions may overlap with the first region, the second regions may each be a different colour, the second regions may each be a different size, the second regions may be different shapes, the second regions may not be displayed until the touch is detected on the first region, etc.

In certain embodiments, the movement of the touch from the first region to the second region may include dragging the object making the touch (e.g., a finger or stylus) from the first region to the second region either directly (e.g., in a substantially straight line) or indirectly (e.g., following a curved path or a more-random path). In an example, it may be required that the object making the touch does not lift-off the touch screen at all throughout this movement (or does not move out of hovering distance away from the touch screen, for the case of a hovering type input being suitable). In another example, the user may have a limited amount of time to move the touch to the second region; that is, a timeout will occur if the user does not move the touch from the first region all the way into the second region within a predetermined period of time, where timeout may result in removal of the indication of the second region (and, optionally, the first region also) so as to prevent provision of the first user input until the method is restarted.

In certain embodiments, maintenance of the touch in the second region on the touch screen may comprise holding the touch within the second region, in the sense of keeping the object touching the second region on the touch screen within the boundary of the second region. It will be appreciated that the object may be permitted to overlap with the boundary of the second region to a predetermined extent (for example, at least some part of the object must remain in the second region, or at least a certain percentage of the area touched by the second object must remain in the second region) while still being considered to be maintained within the second region; or, alternatively, any overlap of the object and the boundary of the second region may be regarded as ending the maintenance of the touch in the second region. This may be determined by a setting configured in the device 100.

In certain embodiments, the control means 110 may be configured to output instructions for providing the first user input, so as to aid the user in instructing the vehicle 700 to perform the defined maneuver. The instructions may include text output on the touch screen, audio output by an audio output means (for example, a speaker circuit) of the device 100, a combination thereof, and/or any method suitable for guiding the user through providing the first user input to the device 100 to instruct the vehicle 700 to perform the defined maneuver.

For example, the control means 110 may control to display an indication of the first region on the touch screen and may control to output a first instruction indicating to touch within the first region. This first instruction may take the form of an audio instruction output by the device 100, or text displayed associated with the first region. For example: text may be displayed within the first region, in which case the text could state “Press finger here”; alternatively, text may be displayed in the vicinity of a circular first region (such as to a side of or around the first region), in which case the text could state “Touch within circle”; alternatively, if a slider control is included in the first region, the text could state “Touch slider”, or otherwise indicate how to operate the slider control.

Following this, the control means 110 may be configured to output a second instruction indicating to move the touch from the first region to the second region, without lift-off of the touch. As above, this second instruction may take the form of an audio instruction or text output by the device 100. For example, the second instruction may be text displayed between the first region and the second region and instructing to move (for example, slide) the touch from the first region to the second region. The second instruction may be separate to the first instruction (e.g., output once the touch has been detected on the first region, or output at the same time as the first instruction), or the first and second instructions may be combined to instruct a user to touch the first region and move the touch to the second region. For example, if a slider control is implemented, the second instruction could indicate how to operate the slider control to move the slider control to the second region.

Following this, the control means 110 may be configured to output a third instruction indicating to maintain the touch in the second region. As above, this third instruction may take the form of an audio instruction or text output by the device 100. For example, the second third may be text displayed associated with the second region, such as on the second region or in the vicinity of the second region. The third instruction may be separate to the first instruction and/or the second instruction (e.g., output once the touch has been detected on the first region, output once the touch has been moved to the second region, and/or output at the same time as one or more of the first and second instructions), or the third instruction and one or more of the first and second instructions may be combined to instruct a user to perform the relevant combination of touching the first region, moving the touch to the second region, and maintaining the touch in the second region. For example, if a slider control is implemented, the third instruction could indicate how to operate the slider control to maintain the slider control in the second region.

In certain embodiments, the signal relating to the defined maneuver, which is transmitted to the vehicle 700 in dependence on maintenance of the touch in the second region, may be a signal which instructs the vehicle 700 to perform the defined maneuver. That is, the signal and/or the vehicle 700 (or a control means of the vehicle 700) is configured such that the vehicle 700, upon receipt of the signal, begins performing the defined maneuver or, if already begun, keeps performing the defined maneuver.

In certain embodiments, the signal may instruct the vehicle 700 to perform the defined maneuver, and the vehicle may determine how to control itself (i.e., one of more of its components) to perform the defined maneuver. In other embodiments, the continuous provision of the signal may provide the vehicle 700 with instructions as to how to perform the defined maneuver, throughout the process of performing the defined maneuver. For example, at any given point during the performing of the defined maneuver, the signal may instruct the vehicle 700 as to one or more of a wheel direction, a wheel speed, a vehicle orientation, a vehicle speed etc. It will be appreciated that these instructions may, for example, be based on information received from the vehicle 700, such as information detected by one or more sensors of the vehicle 700, which may be used by the device 100 to determine how the vehicle 700 should control to perform the defined maneuver. In some examples, the control means 110 may adjust the signal to be transmitted while the performing of the defined maneuver progresses, so as to provide an instruction to the vehicle 700 as to how to perform separate parts of the defined maneuver. For instance, a signal may initially instruct the vehicle 700 to move forwards with a first wheel-direction, and later the signal may be adjusted to instruct the vehicle 700 to move forwards with a second wheel-direction so as to effect a turn required by the defined maneuver.

In certain embodiments, the signal may be initially transmitted at the time the touch is moved to the second region or after at least a period of maintaining the touch in the second region (this period of time may be predetermined). The continuous reception of the signal by the vehicle 700 may cause the vehicle 700 to perform and continue performing the defined maneuver.

In certain embodiments, the control means 110 may be configured to perform one of more of: stopping transmitting of the signal if it is detected that the touch is no longer maintained in the second region; modifying the signal if it is detected that the touch is no longer maintained in the second region; and stopping transmitting the signal to the vehicle 700 and transmitting another signal to the vehicle 700 if it is detected that the touch is no longer maintained in the second region.

Accordingly, it will be appreciated that certain embodiments of the present invention provide a “dead man's handle”. That is, if the user stops maintaining the touch in the second region (i.e., if the first user input stops being detected/received by the device 100), performance of the defined maneuver by the vehicle 700 may halt.

Accordingly, the vehicle 700 may not perform the defined maneuver unless the user is providing the first user input, where the first user input requires the user to maintain contact with the specific second region of the touch screen with the object used to touch the first region. Should the user become incapacitated or otherwise no longer intending performing of the defined maneuver, it is likely that the touch will move out of the second region or lose contact with the touch screen entirely, stopping the performing of the defined maneuver.

Furthermore, as described above the requirements of the first user input are such that providing the first user input does not require a high cognitive load of the user, where this includes the part of maintaining the touch in the second region. Accordingly, the user can give more attention/focus to supervising the vehicle 700 as it performs the defined maneuver, as opposed to having to give further attention to the device 100 to ensure that the correct input is being provided. This also increases functionality, as the user is more aware of the vehicle 700 and its surroundings while the defined maneuver is being performed.

For example, if the user moves the touch out of (or sufficiently out of) the second region or even removes the touch from the touchscreen altogether, the control means 110 may stop transmitting the signal instructing the vehicle 700 to perform the defined maneuver. The vehicle 700, upon no longer receiving the signal, pauses, stops or cancels the performing of the defined maneuver. In another example, if the user moves the touch out of (or sufficiently out of) the second region or even removes the touch from the touchscreen altogether, the control means 110 may modify the signal from the signal instructing the vehicle 700 to perform the defined maneuver to a signal instructing (or indicating to) the vehicle 700 to pause, stop or cancel performing the defined maneuver. In yet another example, if the user moves the touch out of (or sufficiently out of) the second region or even removes the touch from the touchscreen altogether, the control means 110 may stop transmitting the signal instructing the vehicle 700 to perform the defined maneuver and may transmit another signal which instructs the vehicle 700 (or indicates to the vehicle 700) to pause, stop or cancel performing the defined maneuver.

In certain embodiments, the vehicle 700 may continue to perform the defined maneuver until the defined maneuver is completed, until the signal is no longer received, until the modified signal is received, or until some other predefined criteria is met (such as an obstacle being detected by the vehicle 700, or an automatic safety feature requiring that the vehicle 700 ceases performing the defined maneuver).

In certain embodiments, if the defined maneuver is paused or stopped, the control means 110 may be configured to output instructions (for example, in audio form or text form) indicating how to resume performing the defined maneuver. For example, the control means 110 may control to output fourth instructions to indicating that, if the user wishes to resume performing the defined maneuver, the user should provide the first user input again. In another example, if the touch has moved outside the second region but is still on contact with the touch screen, the fourth instructions may inform the user to move the touch back into the second region to resume performing the defined maneuver.

The performing of the defined maneuver may be resumed by the vehicle 700 upon receiving a further signal instructing to perform, or continue performing, the defined maneuver. This further signal may be similar to (or even the same as) the signal relating to the defined maneuver previously transmitted by the device 100 (prior to the pausing/stopping) or may be different in dependence of the vehicle 700 being midway through performing the defined maneuver.

In certain embodiments, the control means 110 may output instructions informing how to stop the performing of the defined maneuver. For example, the control means 110 may control an audio means to output fifth instructions or control the display means 120 to display fifth instructions, where the fifth instructions indicate to remove the touch from the second region to pause, stop or cancel the performing of the defined maneuver. For example, when a slider control is implemented for receiving/providing the first user input, the control means 110 may control to display a message instructing how to stop the defined maneuver in or around the first region, in or around the second region, or elsewhere on the touch screen.

In certain embodiments, the control means 110 may be configured to: detect that maintenance of the touch in the second region has ended (i.e., to detect that the touch is no longer maintained in the second region); and display, on the touch screen, one or more of: an item for changing a power mode of the vehicle 700, an item associated with locking the vehicle 700, an item for ending performing of the defined maneuver, an item for returning to performing of the defined maneuver, and an item for undoing the defined maneuver. One or more of these items may be selectable user interface elements.

In certain embodiments, the control means 110 may be configured to: detect a user input to select one of the displayed one or more items; and transmit another signal to the vehicle 700 in dependence on the selected item. It is advantageous to refer to this user input to select one of the displayed one or more items as a second user input, in view of existing reference to a first user input.

For example, displaying the item for returning to performing the defined maneuver may be accompanied by the fourth instructions indicating how the performing of the defined maneuver can be resumed. Alternatively, if a different function of the device 100 has been executed since the performing of the defined maneuver has been paused, such that the display means 120 no longer displays (at least in a foreground) a GUI associated with performing the defined maneuver but instead displays a different application or another GUI, the item for returning to performing the defined maneuver may be a selectable item which, if selected, causes the display means 120 to again display (in a foreground) the GUI associated with performing the defined maneuver. Once the GUI associated with performing the defined maneuver is again displayed on the touch screen, the fourth instructions may be output by the device 100.

In another example, displaying the item for ending performing of the defined maneuver may be accompanied by the fifth instructions indicating how to stop the performing of the defined maneuver. Alternatively, the item for ending the performing of the defined maneuver may be an item displayed when the performing of the defined maneuver is paused or stopped, and selecting the item for ending performing the defined maneuver informs the control means 110 that the user no longer wishes to, or intends to, performing the defined maneuver, and/or causes the control means 110 to transmit, to the vehicle 700, a signal indicating that the performing of the defined maneuver has ended (i.e., will not be resumed).

In another example, the item for changing the power mode of the vehicle 700 may be a selectable item for turning the vehicle 700 on or off. That is, if selection of this item is detected by the control means 110, the control means 110 may transmit, to the vehicle 700, a signal for controlling a power mode of the vehicle 700, where said signal may instruct the vehicle 700 to turn off, turn on, start an engine, turn-off an engine etc.

In another example, the item associated with locking the vehicle 700 may be a selectable item associated with locking the vehicle 700; that is, an item for locking and/or unlocking one or more doors of the vehicle 700. For example, if the control means 110 detects selection of this item, the control means 110 may transmit a signal to the vehicle 700 instructing the vehicle 700 to: lock all doors of the vehicle 700, lock any unlocked doors of the vehicle 700, unlock one or more doors of the vehicle 700, and/or unlock one or more user-specified doors of the vehicle 700. In another example, if the control means 110 detects selection of the item associated with locking the vehicle 700, the control means 110 control to display a GUI for controlling a lock state of each door of the vehicle 700; wherein, upon receipt of an input through the GUI to instruct locking or unlocking of a door of the vehicle 700, the control means 110 is configured to transmit a signal indicating this instruction to the vehicle 700 so as to cause the vehicle 700 to lock or unlock the door as instructed.

In another example, the item for undoing the defined maneuver may be a selectable item for instructing the vehicle 700 to substantially return to a previous location (and, optionally, orientation) which the vehicle 700 was in prior to receiving the signal to perform the defined maneuver or prior to beginning performing of the defined maneuver.

For example, if the defined maneuver was a maneuver by which the vehicle 700 drives directly forwards by a predetermined distance and the vehicle 700 has either completed or begun performing the defined maneuver: if the control means 110 detects selection of the item for undoing the defined maneuver, the control means 110 may be configured to transmit, to the vehicle 700, a signal instructing the vehicle 700 to undo the defined maneuver; and, upon reception of the signal, the vehicle 700 may be configured to reverse directly backwards by the predetermined distance, thereby effectively undoing the defined maneuver by returning to the previous location.

In another example, if the defined maneuver is a reverse-left parallel park maneuver and the vehicle 700 has either completed or begun performing the defined maneuver: if the control means 110 detects selection of the item for undoing the defined maneuver, the control means 110 may be configured to transmit, to the vehicle 700, a signal instructing the vehicle 700 to undo the defined maneuver; and, upon reception of the signal, the vehicle 700 may be configured to drive forwards-and-right (or in whatever direction necessary) to return to the location of the vehicle 700 prior to the vehicle 700 having initiated performing of the defined maneuver.

In certain embodiments, the control means 110 may only transmit the signal relating to the defined maneuver to the vehicle 700 if the device 100 is authenticated (it will be appreciated that this may also be thought of as a user of the device 100 being authenticated). Additionally or alternatively, in certain embodiments the vehicle 700 may only receive the signal or perform the defined maneuver in dependence on the received signal if the device 100 has been authenticated. Regarding the former the vehicle 700 may not ‘receive’ the signal in the sense of not processing the signal further in response to having determined (by some earlier processing) that the signal does not originate from an authenticated device.

Here, being authenticated may refer to the device 100 being authenticated with the vehicle 700, and/or with a server associated with the vehicle 700, and/or in a service supporting remote access/control between the device 100 and the vehicle 700.

For example, authentication of the device 100 may comprise one or more of: verifying an user account name/number for a user of the device 100, verifying one or more of a password, PIN, biometric information associated with the user account name/number, certificate and/or key exchange between the device 100 and the vehicle 700, and successful completion of out-of-bound authentication (for example, using SMS communications with the mobile terminal 100).

Furthermore, in certain embodiments, even the device 110 is authenticated, it may be required that an external device (different to the device 100) is within a predetermined range from the vehicle 700 and/or the device 100 (whether or not the external device must be in range of the vehicle 700, the device 100 or both the vehicle 700 and the device 100 may be set by an authenticated user, a manufacturer, or any other authenticated party).

For example, if the external device is not within the predetermined range from the vehicle 700, the vehicle 700 may not allow authentication of the device 100, may not receive the signal relating to the defined maneuver (as above) or may ignore the signal relating to the defined maneuver (i.e., not perform the defined maneuver as instructed by the signal). As another example, if the external device is not within the predetermined range from the device 100, the device 100 may not transmit the signal relating to the defined maneuver, or the device 100 may not perform the authentication. It will be appreciated that the predetermined range from the vehicle 700 may be set to be different or the same as the predetermine range from the device 100.

In certain embodiments, the external device is a key-fob, wherein the key-fob may be configured to communicate with one or more of the vehicle 700 and the device 100. For example, the key-fob may be arranged to communicate using RF, WiFi or Bluetooth with the vehicle 700 and/or the device 100, thereby allowing for it to be determined (by the vehicle 700 or the device 100 as appropriate) whether the key-fob is within the respective predetermined range. In certain embodiments, the key-fob itself will be associated with the vehicle 700, in the sense of being unique to the vehicle 700 and allowing access to one or more functions associated with the vehicle 700 (such as instructing the performing of a defined maneuver).

In certain embodiments, the control means 110 may be configured to: when the first user input is not being detected, display a first UI on the touch screen; and, while the first user input is being detected, display a second UI, different to the first UI, on the touch screen. For example, if a GUI associated with performing a defined maneuver is displayed on the touch screen, the form of the GUI will change when the first user input is received. For example, a shape, colour, design, size, background, position etc. of the GUI may change when the first user input is detected or, more specifically, when the touch is detected in the first region, when the touch is moving to the second region, or while the touch is maintained in the second region.

In certain embodiments, the second UI may comprise a message indicating that the defined maneuver is being performed. For example, while the first user input is being detected (and so while the touch is being maintained in the second region) and so while the signal relating to the defined maneuver is being transmitted to the vehicle 700, a GUI associated with performing the defined maneuver may display a message indicating that the defined maneuver is being performed, thereby informing the user.

In certain embodiments, the control means 110 may be configured to control to display an indication of the defined maneuver on the touch screen. For example, before the first user input is detected or while the first user input is being detected, the control means 110 may display, in or on a GUI associated with performing the defined maneuver, an indication of the defined maneuver. Said indication may be static or animated and may be a representation of a vehicle performing a representation of the defined maneuver. In another example, the control means 110 may be configured to output an audio indication of the defined maneuver.

In certain embodiments, the control means 110 may be configured to: display at least one defined maneuver for the vehicle 700 on the touch screen; and detect a selection of the defined maneuver from the displayed at least one defined maneuver, before detecting the first user input. For example, the control means 110 may display a list of at least one defined maneuver, from which a user may select a defined maneuver for the vehicle 700 to perform.

In certain embodiments, the at least one defined maneuver may be at least one candidate defined maneuver chosen from among a plurality of defined maneuver based on one or more characteristics of the vehicle 700. For example, certain types of vehicle 700 may only be able to perform a subset of the plurality of defined maneuvers, in which case the at least one candidate defined maneuver should not include a defined maneuver that the vehicle 700 cannot perform. In other embodiments, the at least candidate defined maneuver may be chosen based on determining defined maneuver(s) currently available to the vehicle 700. For example, if a vehicle 700 is unable to perform a parking maneuver due to a lack of available parking spaces, then a parking-related defined maneuver will not be among the displayed at least one defined maneuver. In certain embodiments, the device 100 may determine the at least one candidate defined maneuver in dependence on information received from the vehicle 700.

In certain embodiments, the displayed at least one defined maneuver may comprises one or more of: a parallel park maneuver, a perpendicular park maneuver, a forward maneuver, a forward-left maneuver, a forward-right maneuver, a reverse maneuver, a reverse-left maneuver, a reverse-right maneuver, and a longitudinal adjustment maneuver.

In certain embodiments, the control means 110 may be configured to determine whether a battery (or power supply) of the device 100 (not shown in FIG. 1) has at least a predetermined level of charge remaining in order to transmit the signal relating to performing the defined maneuver. In certain embodiments, the control means 110 may be configured to determine whether a battery of the device 100 has at least a predetermined level of charge remaining in order to transmit the signal relating to performing the defined maneuver for the duration of the defined maneuver.

In certain embodiments, the control means 110 may be configured to: determine whether the device 100 is within a predetermined range from the vehicle 700, and transmit the signal relating to the defined maneuver only if the device 100 is within the predetermined range from the vehicle 700. Accordingly, the device 100 may be provided with means for determining a relative distance to, or relative location of, the vehicle 700 from the device 100 (and/or determining a relative distance to, or relative location of, the device 100 from the vehicle 700).

It will be appreciated that the above-described operation(s) of the control means 110 may be implemented through the provision of a computer readable medium comprising computer readable instructions that, when executed by a processor (as may be included in the control means 110) cause performance of a method which includes one or more of the operations disclosed above. Furthermore, it will be appreciated that the embodiments and examples of the present invention above may readily be combined (as appropriate) as desired.

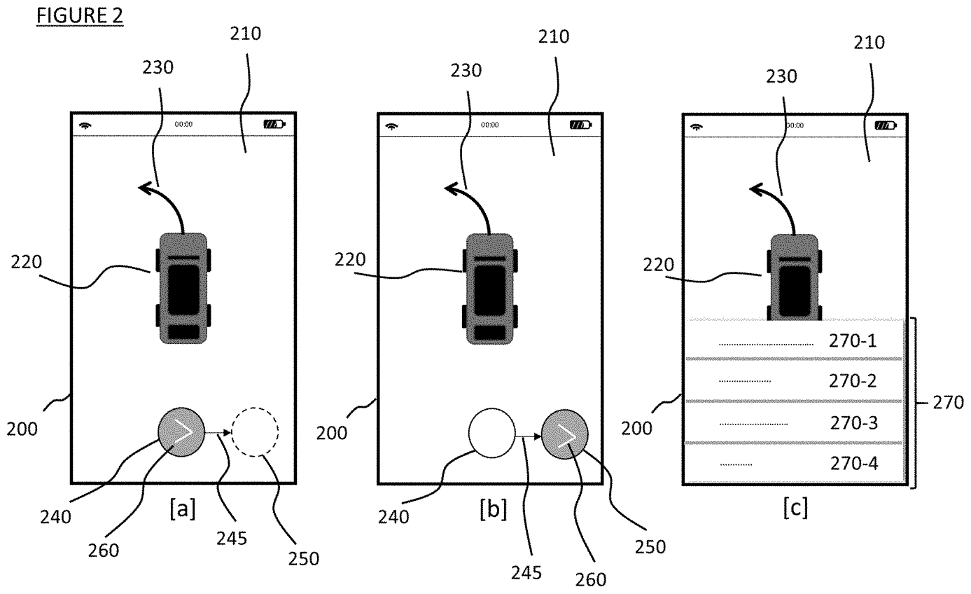

FIG. 2 shows a GUI according to an embodiment of the present invention.

Referring to FIG. 2[a], there is shown a schematic illustration of a touch screen 200 of a device 100, such as may be included in the display means 120 and/or input means 130 of the device 100. The touch screen 200 displays a GUI 210. The GUI 210 may be displayed under the control of the control means 110. For example, the GUI 210 may be provided by computer software (for example, an application), stored in the storage means 140 and executed by the control means 110 (for example, by at least one processor included in the control means 110) such that the GUI 210 is provided.

The GUI 210 may include a vehicle representation 220. The vehicle representation 220 may correspond to a type or model of the vehicle 700, or may represent a generic vehicle.

The GUI 210 may include a defined maneuver representation 230. The defined maneuver representation 230 may correspond, for example, to a defined maneuver selected, by a user, to be performed by the vehicle 700. Said selection may have been made from a list of defined maneuvers previously displayed on the touch screen 200, for example via another screen provided by the GUI 210 (not shown). The defined maneuver representation 230 may therefore show the defined maneuver which the vehicle 700 will be instructed to perform, if the first user input is detected.

The GUI 210 may include an indication of a first region 240. In the example shown in FIG. 2, the area of the first region 240 corresponds to a circle located in a bottom-middle part of the touch screen 200. Various characteristics and features of a first region have been discussed above in relation to FIG. 1, and it will be appreciated that any of said characteristics or features could be implemented here, instead of (or in addition to) what is shown in FIG. 2. To give some non-limiting examples: the first region 240 could be located differently on the touch screen 200, or could be a different shape, and/or could be displayed with a first instruction (as described above).

The GUI 210 may include an indication of a direction 245 to an indication of a second region 250. The direction 245 is represented using an arrow pointing from the first region 240 to the second region 250. In the example shown in FIG. 2, the area of the second region 250 corresponds to a circle located in a bottom-right part of the touch screen 200. Here, the second region 250 is shown with a different form (having a broken outline) to the first region 240, thereby aiding in distinguishing the first region 240 and the second region 250. In FIG. 2, the indication of the second region 250 is shown to be displayed even before the touch of the first user input is received in the first region 240; however it will be appreciated that, in another example, the second region 250 and/or the direction 245 may be hidden (i.e., not displayed) until the touch is received, thereby ensuring a user does not accidentally confuse the first region 240 with the second region 250 prior to providing the touch.

It will be appreciated that the GUI 210 may display a second instruction (as described above), to inform a user to move a touch in the first region 240 to the second region 250. Additionally, it will be appreciated that the GUI may display a third instruction (as described above), to inform a user to maintain the touch in the second region 250 once having moved the touch to the second region 250. As described above, any combination of first, second and third instructions may be displayed, where the second and third instructions may be displayed responsive to detecting a previous part of the first user input having been performed. For example, the second instructions may be displayed when the touch in the first region 240 is detected and the third instructions may be displayed when the touch is moved to the second region 250; or alternatively the second and third instructions may be displayed with the first instructions prior to a touch on the first region 240 having been detected.

The GUI 210 may include a slider control 260, which is shown located in the first region in FIG. 2[a]. The slider control 260 itself includes an indication of a direction of movement for the slider control 260 (in FIG. 2, this indication is an arrowhead), thereby providing a subtle instruction to a user as to how to use the slider control 260, separate to the indication of the direction 245.

Referring now to FIG. 2[b], the illustrated GUI 210 shows the slider control 260 having been moved/dragged from the first region 240 to the second region 250 and being maintained in the second region 250. Accordingly, this corresponds to a situation whereby, from the screen shown in FIG. 2[a], a user has touched the slider control 260 on the first region 240 and moved the slider control 260 to the second region 250, where the user is in the process of maintaining the slider control 260 in the second region 250 by keeping the object which is touching the slider control on the touch screen 200 suitably within the boundary of the second region 250.

In response to the slider control 260 being maintained in the second region 250, the control means 110 may be configured to transmit a signal relating to the defined maneuver to the vehicle 700, as described in detail above. Accordingly, the device 100 is instructing the vehicle 700 to perform the defined maneuver as a result of detecting the first user input.

Referring now to FIG. 2[c], the illustrated GUI 210 shows a menu 270 which includes at least one selectable item; in an example, four items 270-1, 270-2, 270-3, 270-4 are included in menu 270, as indicated by the separators in the menu 270. Text indicating or describing each item may be displayed in the menu 270, for example in the positions represented by the dots for each item. Menu items may be arranged in rows as indicated (e.g., in a list form), or may be arranged through another suitable method, such as in a drop-down box.

The menu 270 may be displayed in response to the slider control 260 no longer being maintained in the second region 250. For example, the user may have moved the touch outside of the second region 250 or removed the object which was touching the slider control 260 from the touch screen 200; and this may cause the slider control 260 to revert to the first region 240.

In detecting that the touch (i.e., the slider control 260) is no longer maintained on the second region 250, the control means 110 is arranged to display the menu 270 through the GUI 210. In an example: item 270-1 may be an item for turning off and locking the vehicle 700; item 270-2 may be an item for returning to performing the defined maneuver; item 270-3 may be an item for undoing the defined maneuver; and item 270-4 may be an item for ending performing of the defined maneuver. In an example, to indicate a function linked to each item in menu 270: item 270-1 may be displayed to include the text “Turn off and Lock vehicle”; item 270-2 may be displayed to include the text “Return to maneuver”; item 270-3 may be displayed to include the text “Undo maneuver”; and item 270-4 may be displayed to include the text “End maneuver”. It will be appreciated that the order of the items in the menu 270 may be changed, and/or one of more of these items may not be included, and/or one or more other items may be included.

To give an example, if the item for returning to performing the defined maneuver is selected, a GUI 210 as shown in FIG. 2[a] may again be displayed, thereby allowing a user to touch and drag the slider control 260 from the first region 240 to the second region 250 once again, to again instruct the vehicle 700 to perform the defined maneuver.

In another example, if the item for undoing the defined maneuver is selected, GUI 210 may be configured to allow a user to instruct the vehicle 700 to perform another defined maneuver for the purposes of undoing the defined maneuver or undoing the performed part of the defined maneuver (in the case that the defined maneuver had not been completed). For example, a screen provided by GUI 210 may include a first region 240, a second region 250, an indication of a direction 245, a slider control 260, and a defined maneuver representation 230 corresponding to the another defined maneuver, such that a user may provide the first user input to instruct the vehicle 700 to perform the other defined maneuver. In a further example of this, the defined maneuver representation 230 corresponding to the other defined maneuver is the reverse of the defined maneuver representation 230 shown in FIG. 2[a].

In another example, the menu 270 may be displayed when the defined maneuver is completed, in which case the menu 270 may not include an item for returning to performing the defined maneuver or an item for ending performing of the defined maneuver, and may include an item such as an item for selecting another defined maneuver.

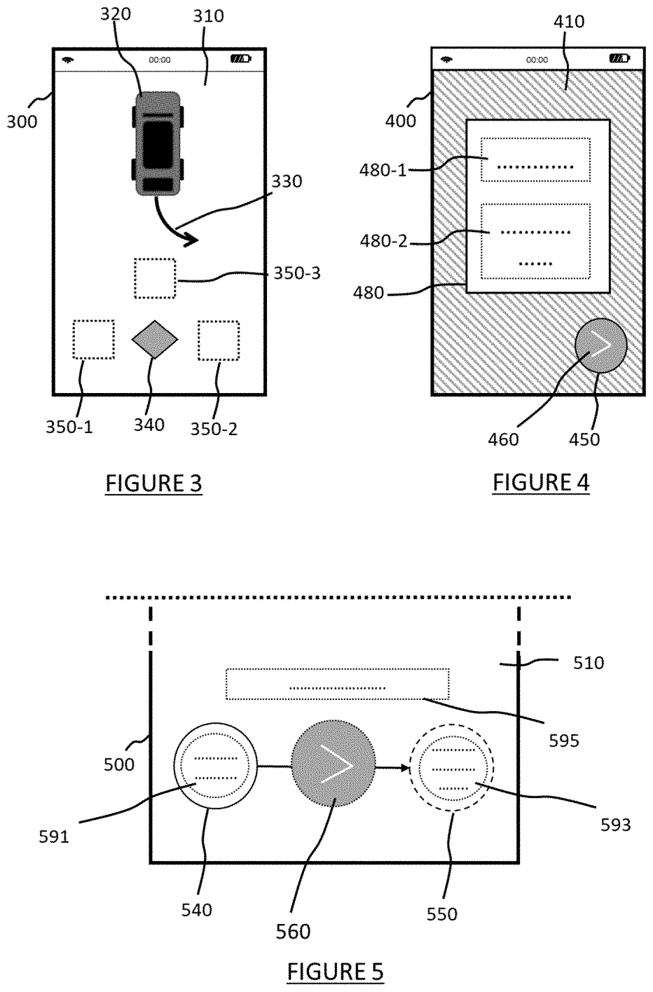

FIGS. 3-5 show further examples of GUIs associated with performing a defined maneuver.

In FIG. 3, a plurality of second regions 350-1, 350-2, 350-3 are included in GUI 310 displayed on touch screen 300. A first region 340 is also displayed, and is defined in a different shape to the first region 240 in FIG. 2 to illustrate this variable characteristic. Similarly, each of the second regions 350-1, 350-2, 350-3 are defined in a different shape to the second region 250 of FIG. 2, and also in a different shape to the first region 340. The defined maneuver is also different to the defined maneuver of FIG. 2, as can be seen from defined maneuver indication 330.

The GUI 310 may include a vehicle representation 320. The vehicle representation 320 may correspond to a type or model of the vehicle 700, or may represent a generic vehicle.

As described above, in the case of a plurality of second regions, the touch on the first region 340 may be moved to any one of the second regions 350-1, 350-2, 350-3 as part of the first user input. To cause transmitting of the signal relating to performing defined maneuver, the touch should be maintained in that one of the second region 350-1, 350-2, 350-3 throughout performance of the defined maneuver by the vehicle 700. An advantage of providing a plurality of second regions 350-1, 350-2, 350-3 is that a user has the choice of moving to a second region which is most comfortable for them according to their mobility and dexterity.

In FIG. 4, a GUI 410 displayed on the touch screen 400 shows an example of a screen of GUI 410 which may be output while the signal relating to the defined maneuver is being transmitted and/or the vehicle 700 is performing the defined maneuver. It can be seen that slider control 460 is being maintained on the second region 450, and so the first user input is detected by the control means 110 leading to transmitting of the signal related to the defined maneuver.

A screen of GUI 410 may not show one or more of the UI elements shown on a GUI such as GUI 210 described in relation to FIG. 2. For example, the first region 240 and the direction 245 may not be displayed, and the vehicle representation 220 and the defined maneuver representation 230 may not be displayed. Instead, a message 480 may be displayed over a background of GUI 410, over which the second region 450 and slider control 460 are visibly displayed. The message 480 may include one or more messages or pieces of text (in place of the dots shown in the figure, for example), such as one or more instructions or indications of a current state of the vehicle 700 or the defined maneuver.

In FIG. 4, the message 480 includes two messages 480-1, 480-2, however it will be appreciated that more or fewer messages could be included. In an example, message 480-1 may indicate that the defined maneuver is in progress; for example, the text “Maneuver in Progress” may be displayed within message 480-1. In an example, message 480-2 may indicate how to pause the performing of the defined maneuver; for example, the text “Release touch to pause maneuver” may be displayed within message 480-2. It will be appreciated that message 480-1 and message 480-2 could be combined into a single message, if desired. Advantageously, by removing one or more UI elements and instead displaying a message (such as message 480) guiding a user through the task of controlling the performing of the defined maneuver by the vehicle 700, user comprehension is increased at least through the removal of potentially distracting UI element(s).

FIG. 5 shows a close-up of an example of a GUI 510 associated with performing a defined maneuver displayed on a touch screen 500. Here, the focus is on a first region 540 and a second region 550 which are displayed through the GUI 510. Additionally, a slider control 560 is displayed in the process of being moved from the first region 540 to the second region 550.

In this example, a first message 591 may be displayed within the first region 540. In some examples, the first message 591 will additionally or alternatively be displayed when the slider control 560 is in the second region 550. The first message 591 may include text, as indicated by the dots in first message 591. In an example, the first message 591 may include instructions as to how to stop or pause the instructing of the vehicle 700 to perform of the defined maneuver. For example, the first message 591 may include the text “Release to stop”. If the slider control 560 is released before reaching the second region 550, the defined maneuver will not be initiated in the first place and the slider control 560 may return to the first region 540.

A second message 593 may be displayed in the second region 550. The second message 593 may include text, as indicated by the dots in the second message 593. The second message 593 may include instructions as to how to trigger performing of the defined maneuver, such as by instructing a user to move/slide the slider control 560 to the second region 550. For example, the second message 593 may include the text “Slide here to move”. In an example, when the slider control 560 reaches the second region 550, the content of the second message 593 may change or a new second message may be displayed to indicate that performing the defined maneuver is in progress. For example, the GUI 510 may be configured to resemble GUI 410 of FIG. 4, such as providing a screen corresponding to that shown in FIG. 4.

A third message 595 may be displayed over part of a background of the GUI 510. The third message 595 may include text, as indicated by the dots in the third message 595. The third message 595 may include instructions for how to provide the first user input and thus how to move the vehicle 700 according to a desired defined maneuver. For example, the third message 595 may include the text “Slide and hold to move vehicle”.

Any combination of the first message 591, second message 593 and third message 595 may be displayed to guide a user through performing the interaction with the GUI 510 to instruct the vehicle 700 to perform the defined maneuver.

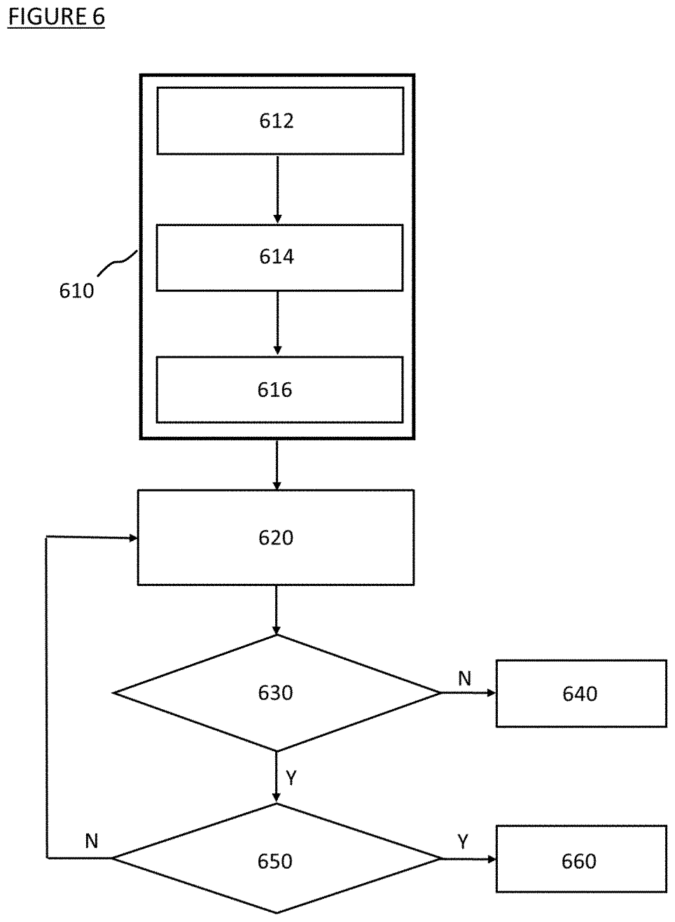

FIG. 6 shows a flow diagram illustrating a method according to an embodiment of the present invention. It will be appreciated that the method may be performed by a device 100 (such as by a control means 110 of a device 100), and may be performed by providing a computer readable medium comprising computer readable instructions that, when executed by a processor (included in the control means 110, for example), cause performance of the method.

The different boxes in FIG. 6 may be labelled as follows:
Operation 610—“Detect first user input for a vehicle to perform a defined maneuver”
Operation 612—“Detect a touch in a first region”
Operation 614—“Detect movement of the touch to a second region”.
Operation 616—“Detect maintenance of the touch in the second region”.
Operation 620—“Transmit a signal relating to the defined maneuver”.
Operation 630—“Touch maintained in the second region?”.
Operation 640—“Stop transmitting the signal”.
Operation 650—“Defined maneuver complete?”.
Operation 660—“End”.

As illustrated: Operation 630 leads to Operation 640 if the outcome of Operation 630 is negative (“N”), and Operation 630 leads to Operation 650 if the outcome of Operation 630 is positive (“Y”); and Operation 650 leads to Operation 620 if the outcome of Operation 650 is negative (“N”); and Operation 650 leads to Operation 660 if the outcome of Operation 650 is positive (“Y”). This is discussed further below.

In Operation 610, the device 100 detects, on a touch screen of the device 100, a first user input for a vehicle 700, which may be remote to the device 100, to perform a defined maneuver. In certain embodiments, Operation 610 may be regarded as comprising several separate/sequential operations including:
Operation 612, in which the device 100 detects a touch on a first region on the touch screen;
Operation 614, in which the device 100 detects movement of the touch to a second region on the touch screen; and
Operation 616, in which the device 100 detects that the touch is maintained in the second region.

In operation 620, the device 100 transmits a signal relating to the defined maneuver to the vehicle 700. This is performed in dependence on the touch being maintained in the second region, and as such, if the device 100 does not detect the touch being maintained in the second region in Operation 616 (or in Operation 610), the device 100 does not transmit the signal.

In Operation 630, the device 100 detects (or determine) whether the touch is maintained in the second region. If the touch is maintained in the second region, the method proceeds to Operation 650. If the touch is not maintained in the second region, the method proceeds to Operation 640.

In Operation 640, if the device 100 detects that the touch is not maintained in the second region, the device 100 stops transmitting the signal to the vehicle 700, thereby causing the vehicle 700 to pause performing the defined maneuver. In an alternative embodiment, as described above the device 100 may instead transmit a modified signal to the vehicle 700, where the modified signal instructs the vehicle 700 to pause performing the defined maneuver. In certain embodiments, the device 100 may subsequently display a menu, such as shown in FIG. 2[c], which provides various selectable items to a user, allowing a user to choose to return to performing the defined maneuver, to end performing of the defined maneuver, to undo the performing of the defined maneuver etc.

In Operation 650, if the device 100 detects that the touch is maintained in the second region, the device 100 determines if the defined maneuver is completed. For example, the device 100 may receive information relating to the performing of the defined maneuver from the vehicle 700, where said information may include an indication that the defined maneuver has been completed. In another example, the device 100 itself may be configured to monitor or receive information on a condition associated with the vehicle 700 so as to determine whether the defined maneuver is completed. For example, the device 100 may use one or more of a location of the vehicle 700, an orientation of the vehicle 700, a travelled path of the vehicle 700, a speed of the vehicle 700 and information received from the vehicle to determine whether the vehicle 700 has completed the defined maneuver.

If the outcome of Operation 650 is that the defined maneuver is complete, the method proceeds to Operation 660. In Operation 660, the method ends in view of the vehicle 700 being determined to have performed the defined maneuver. The touch in the second region may therefore be released. The signal may not be transmitted in Operation 660 regardless of whether the touch is still maintained in the second region, as the device 100 has determined that the defined maneuver is complete. In Operation 660, a GUI associated with performing the defined maneuver, displayed on the touch screen of the device 100, may change to reflect the defined maneuver having been performed. For example, one or more items may be included in a menu output the GUI, such as an item for changing a power mode of the vehicle 700, an item associated with locking the vehicle 700, an item for selecting a new defined maneuver, and an item for undoing the defined maneuver.

If the outcome of Operation 650 is that the defined maneuver is not complete, the method returns to Operation 620, where the device 100 transmits the signal related to the defined maneuver to the vehicle 700. Accordingly, the device 100 may continue to instruct the vehicle 700 to perform the defined maneuver in view of having detected the touch to be maintained in the second region while the defined maneuver is not complete. Following this, the method proceeds again to Operation 630 in which it is detected if the touch is still maintained in the second region. The method then proceeds as above, until Operation 640 or Operation 660 is reached.

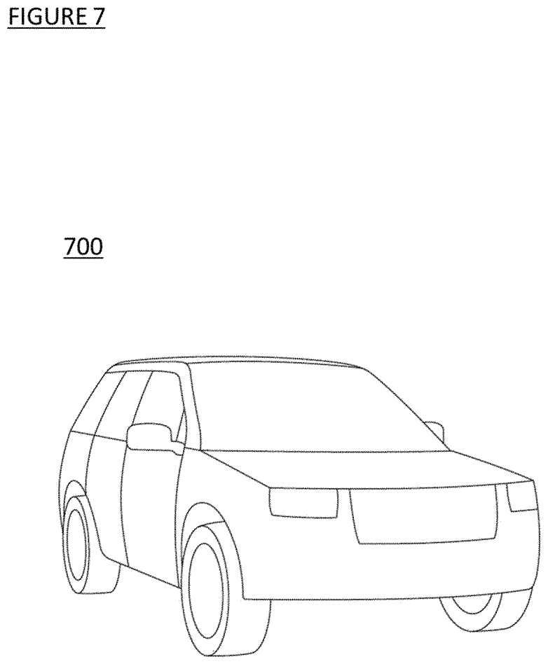

FIG. 7 shows a vehicle 700 according to an embodiment of the present invention. Further embodiments of the present invention relate to a system including a vehicle 700, such as that shown in FIG. 7, and a device 100 such as that of any of the embodiments described above. In such embodiments, the vehicle 700 and the device 100 included in the system may be considered to be interrelated.

In certain embodiments, the vehicle 700 comprises: an input means configured to receive, from a device 100, a signal relating to a defined maneuver; an output means configured to output a movement signal to cause an application of torque to one or more wheels of the vehicle 700 to move the vehicle 700; and a control means configured to control the output means of the vehicle 700 to output the movement signal in dependence on the signal being received from the device 100.

Accordingly, the control means of the vehicle 700 may control the output means of the vehicle 700 to output the movement signal so as to perform the defined maneuver in dependence of the signal relating to the defined maneuver being received from the device 100. For example, when the signal relating to the defined maneuver is received, the control means of the vehicle 700 may control the output means of the vehicle 700 to output the movement signal to cause performing of the defined maneuver; and when the signal relating to the defined maneuver is no longer receiver (e.g., the receiving of the signal is interrupted), the control means 110 may stop controlling the output means of the vehicle 700 to output the movement signal.

In certain embodiments, the input means may comprise input circuitry, the output means may comprise output circuitry, and the control means may comprise control circuitry, where the control circuitry may include one or more electronic processing devices such as an electronic processor.

It will be appreciated that the vehicle 700 may include one or more components in addition to those indicated above. For example, the vehicle 700 may include storage means (such as one or more memory unit), display means (such as a display unit or a touch screen display unit), audio output means (such as a speaker), etc.

It will be appreciated that embodiments of the present invention can be realised in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as claimed in any preceding claim and a machine-readable storage storing such a program. Still further, embodiments of the present invention may be conveyed electronically via any medium such as a communication signal carried over a wired or wireless connection and embodiments suitably encompass the same.

The expression “configured to” used in the present disclosure may be exchanged with, for example, “arranged to”, “having the capacity to”, “designed to”, “capable of”, “adapted to”, “made to”, or “suitable for” according to the situation. The term “configured to” may not necessarily imply “specifically designed to” in hardware. Alternatively, in some situations, the expression “device configured to” may mean that the device, together with other devices or components, “is able to”. For example, the phrase “processor adapted (or configured) to perform A, B, and C” may mean a dedicated processor (e.g., embedded processor) only for performing the corresponding operations or a generic-purpose processor (e.g., central processing unit (CPU) or application processor (AP)) that can perform the corresponding operations by executing one or more software programs stored in a memory device.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

1. A non-transitory computer readable medium comprising computer readable instructions that, when executed by a processor, cause performance of a method comprising:
detecting, on a touch screen of a device, a first user input for a vehicle, remote to the device, to perform a defined maneuver, wherein the first user input comprises a touch moving from a first region on the touch screen to a second region on the touch screen, and maintenance of the touch in the second region on the touch screen; and
transmitting, by the device, a signal relating to the defined maneuver to the vehicle in dependence on maintenance of the touch in the second region.

2. The non-transitory computer readable medium of claim 1, wherein the method comprises one or more of:
stopping transmitting the signal if it is detected that the touch is no longer maintained in the second region; and
modifying the signal if it is detected that the touch is no longer maintained in the second region.

3. The non-transitory computer readable medium of claim 2, wherein the modified signal instructs the vehicle to pause performing the defined maneuver.

4. The non-transitory computer readable medium of claim 2, wherein the method comprises:
if it is detected that the touch is no longer maintained in the second region, displaying a message indicating how the defined maneuver can be resumed.

5. The non-transitory computer readable medium of claim 1, wherein the signal instructs the vehicle to begin performing the defined maneuver.

6. The non-transitory computer readable medium of claim 1, wherein the touch moves a slider control, displayed on the touch screen, from the first region to the second region.

7. The non-transitory computer readable medium of claim 6, wherein one or more of:
a message instructing how to operate the slider control is displayed associated with the second region, before the first user input is detected; and
a message instructing how to stop the defined maneuver is displayed associated with the first region, when the slider control is moved or moving to the second region.

8. The non-transitory computer readable medium of claim 1, wherein:
the first region is located to the left of the second region in a graphical user interface, GUI, associated with the defined maneuver displayed on the touch screen;
the first region is located to the right of the second region in the GUI displayed on the touch screen;
the second region is located around the first region in the GUI displayed on the touch screen; or
the second region comprises two or more separate regions displayed in the GUI on the touch screen.

9. The non-transitory compute readable medium of claim 1, wherein the method comprises:
detecting that the touch is no longer maintained in the second region; and
displaying, on the touch screen, one or more of: an item for changing a power mode of the vehicle, an item associated with locking the vehicle, an item for ending performing of the defined maneuver, an item for returning to performing of the defined maneuver, and an item for undoing the defined maneuver.

10. The non-transitory computer readable medium of claim 9, wherein the method comprises:
detecting a second user input to select one of the displayed one or more items; and
transmitting another signal to the vehicle in dependence on the selected item.

11. The non-transitory computer readable medium of claim 1, wherein the method is performed only if a user is authenticated.

12. The non-transitory computer readable medium of claim 1, wherein the method comprises:
displaying a first graphic user interface, GUI, on the touch screen when the first user input is not being detected; and
displaying a second GUI, different to the first GUI, on the touch screen while the first user input is being detected.

13. The non-transitory computer readable medium of claim 12, wherein a message indicating that the defined maneuver is being performed is displayed on the second GUI.

14. The non-transitory computer readable medium of claim 1, wherein the method comprises:
displaying at least one defined maneuver for the vehicle on the touch screen; and
detecting a selection of the defined maneuver from the displayed at least one defined maneuver, before detecting the first user input.

15. The non-transitory computer readable medium of claim 14, wherein the displayed at least one defined maneuver comprises one or more of: a parallel park maneuver, a perpendicular park maneuver, a forward maneuver, a forward-left maneuver, a forward-right maneuver, a reverse maneuver, a reverse-left maneuver, a reverse-right maneuver, and a longitudinal adjustment maneuver.

16. The non-transitory computer readable medium of claim 1, wherein the method comprises:
receiving, from the vehicle, information relating to the performing of the defined maneuver; and
determining whether the vehicle has completed the defined maneuver in dependence on the received information.

17. The non-transitory computer readable medium of claim 16, wherein the method comprises:
if it is determined that the vehicle has completed the defined maneuver, stopping transmitting the signal.

18. A device, comprising:
a touch screen;
an input circuit configured to detect, on the touch screen, a first user input for a vehicle to perform a defined maneuver, wherein the first user input comprises a touch moving from a first region on the touch screen to a second region on the touch screen, and maintenance of the touch in the second region on the touch screen; and
an output circuit configured to transmit a signal relating to the defined maneuver to the vehicle in dependence on maintenance of the touch in the second region.

19. The device of claim 18, wherein at least one of:
the device is required to have at least a predetermined battery level remaining in order to transmit the signal; and
the device is required to remain within a predetermined distance from the vehicle in order to transmit the signal.

20. A vehicle comprising:
an input circuit configured to receive, from a device, a signal relating to a defined maneuver;
an output circuit configured to output a movement signal to cause an application of torque to one or more wheels of the vehicle to move the vehicle; and
a control circuit configured to control the output circuit to output the movement signal in dependence on the signal being received from the device.
